(19) United States
(12) Patent Application Publication
(10) Pub. No.: US 2024/0107596 A1
(43) Pub. Date: Mar. 28, 2024

(54) Device-Driven Network Connection

(71) Applicant: Apple Inc., Cupertion, CA (US)

(72) Inventors: Tarik Tabet, Carlsbad, CA (US); Said Medjkouh, San Diego, CA (US); Sreevalsan Vallath, Dublin, CA (US); Sarma V. Vangala, Campbell, CA (US)

(21) Appl. No.: 17/950,949

(22) Filed: Sep. 22, 2022

(51) Int. Cl. H04W 76/10; H04W 36/22; H04W 60/00; H04W 72/04

(52) U.S. Cl. CPC H04W 76/10; H04W 36/22; H04W 60/00; H04W 72/0453

(57) ABSTRACT

A communications system may include a user equipment (UE) device that communicates with a network. The UE may gather first contextual information about usage of the UE device, may receive second contextual information about usage of the network, and may receive third contextual information about usage of additional UE devices. The UE may run an application that requests wireless data transfer. The UE may train a learning model based on the contextual information. The UE may make a network connectivity decision based on the contextual information, the learning model, and a data sensitivity of the application. Once the connectivity decision is made, signals may be conveyed to implement the decision. Performing the connectivity decision on the UE instead of the network may allow the UE and the network to take full advantage of contextual learning in different use cases to optimize performance of both the UE and the network.

### FIELD

This disclosure relates generally to wireless communications, including wireless communications performed by user equipment devices.

### BACKGROUND

Communications systems often include user equipment devices that convey wireless data with a network. Prior to conveying the wireless data, a user equipment device wirelessly connects or attaches to a node of the network. The network itself coordinates, determines, and sets the configuration with which the user equipment device connects to the network. This type of network-driven connection scheme can lead to inefficient connection decisions and can undesirably limit wireless communications performance.

### SUMMARY

A communications system may include user equipment (UE) devices that communicate with a network such as a cellular network having wireless base stations. A UE device may gather first contextual information about usage or behavior of the UE device (e.g., behavioral patterns, activity patterns, behavioral and activity patterns (BAP), etc.). The UE device may receive second contextual information about usage or behavior of the network. The UE device may receive third contextual information about usage or behavior of a set of additional UE devices. The UE device may transmit the first contextual information to the network and the set of additional UE devices. The contextual information may incorporate information about the state of the device(s) (e.g., battery state, available resources, user activity, user intent, sensor information, etc.).

The UE device may run an application that requests wireless data transfer. The application may have a corresponding application data sensitivity. The UE device may maintain and train a learning model based on the first, second, and/or third contextual information. The UE device may make a network connectivity decision (e.g., may wirelessly connect to the network) based on the first contextual information, the second contextual information, the third contextual information, an output of the learning model, and/or the application data sensitivity. The network connectivity decision may include a decision to delay or start wireless data transfer, a decision to switch wireless base stations or frequencies, a decision to reduce data quality, or a decision to negotiate a wireless connectivity configuration with the network, as examples.

Once the UE device has made the network connectivity decision, signals may be conveyed between the UE device and the network to implement the network connectivity decision (e.g., to wirelessly connect or reconfigure the wireless connection of the UE device to the network). Using the UE device to perform the network connectivity decision instead of the network may allow the UE device and the network to take full advantage of contextual learning and information available only at the UE device in different use cases to optimize the overall wireless performance of both the UE device and the network.

An aspect of the disclosure provides a method of operating a user equipment (UE) device. The method may include with one or more antennas, receiving a first signal from a first wireless base station of a cellular network, the first signal including first contextual information about the cellular network. The method may include with one or more processors, wirelessly connecting the UE device to the cellular network based on the first contextual information. The method may include with the one or more antennas, once the UE device has wirelessly connected to the cellular network, conveying wireless data with the cellular network.

An aspect of the disclosure provides a method of operating a user equipment (UE) device to communicate with a cellular network. The method may include with one or more processors, gathering first contextual information about usage of the UE device. The method may include with the one or more processors, making a network connectivity decision for the UE device and the cellular network based on the first contextual information. The method may include with one or more antennas, transmitting a signal to the cellular network that implements the network connectivity decision.

An aspect of the disclosure provides a method of operating a user equipment (UE) device to communicate with a cellular network. The method can include with one or more antennas, receiving a first signal that includes first contextual information about usage of a set of additional UE devices that communicate with the cellular network. The method can include with one or more processors, performing a wireless connectivity action with the cellular network based on the first contextual information. The method can include with the one or more antennas, transmitting a second signal to the cellular network that implements the wireless connectivity action.

### BRIEF DESCRIPTION OF THE DRAWINGS

FIG. 1 is a diagram of an illustrative communications system having user equipment devices that communicate with a network in accordance with some embodiments.

FIG. 2 is a schematic block diagram of an illustrative user equipment device in accordance with some embodiments.

FIG. 3 is a diagram showing how illustrative contextual information may be conveyed between a network and a set of user equipment devices for performing network connection decisions in accordance with some embodiments.

FIG. 4 is a diagram showing how an illustrative user equipment device may make network connection decisions based on a learning model and/or contextual information associated with the user equipment device, the network, and/or a set of other user equipment devices in accordance with some embodiments.

FIG. 5 is a flow chart of illustrative operations that may be performed by a user equipment device to perform a network connection action based on a learning model, application data sensitivity, and/or contextual information associated with the user equipment device, the network, and/or a set of other user equipment devices in accordance with some embodiments.

FIG. 6 is a diagram showing how an illustrative user equipment device may make network connection decisions across multiple radio access technologies (RATs) in accordance with some embodiments.

FIG. 7 is a flow chart of illustrative operations that may be performed by a user equipment device to make a network connection decision to start or delay data transfer in accordance with some embodiments.

FIG. 8 is a flow chart of illustrative operations that may be performed by a user equipment device to make a network connection decision based on a connectivity suggestion from a network and based on an application data sensitivity in accordance with some embodiments.

FIG. 9 is a flow chart of illustrative operations that may be performed by a user equipment device to make a network connection decision to switch between wireless base stations in accordance with some embodiments.

FIG. 10 is a diagram showing how an illustrative user equipment device may switch between wireless base stations in accordance with some embodiments.

### DETAILED DESCRIPTION

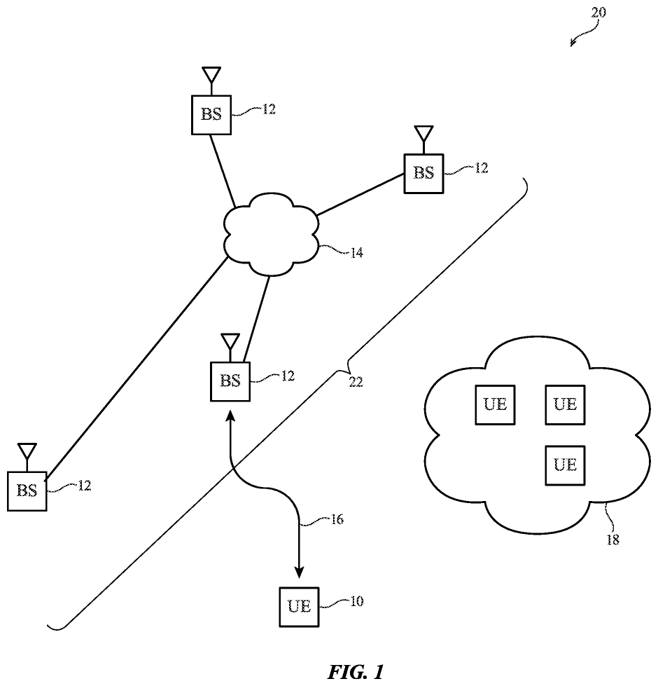

FIG. 1 is a schematic diagram of an illustrative communications system 20 (sometimes referred to herein as communications network 20) for conveying wireless data between communications terminals. Communications system 20 may include network nodes (e.g., communications terminals). The network nodes may include user equipment (UE) such as one or more UE devices 10. The network nodes may also include external communications equipment (e.g., communications equipment other than UE devices 10) such as external communications equipment 12. External communications equipment 12 may include wireless base stations, wireless access points, or other wireless equipment for example. Implementations in which external communications equipment 12 is a wireless base station (BS) that supports cellular telephone communications (e.g., voice and/or data signals) are described herein as an example. External communications equipment 12 may therefore sometimes be referred to herein as wireless base station 12, gNB 12, or simply as base station 12. UE devices 10 and base station 12 may communicate with each other using wireless communications links. If desired, UE devices 10 may wirelessly communicate with base station 12 without passing communications through any other intervening network nodes in communications system 20 (e.g., UE devices 10 may communicate directly with base station 12 over-the-air).

Communications system 20 may form a part of a larger communications network that includes network nodes coupled to base station 12 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in the larger communications network via base stations 12 (e.g., base stations 12 may serve as an interface between UE devices 10 and the rest of the larger communications network).

Some or all of the communications network may, if desired, be operated by a corresponding network operator or service provider. For example, communication system 20 may include a core network (CN) 14 operated by a network operator or service provider. Core network 14 may include end hosts, terminals, network nodes, servers, switches, routers, local area networks, distributed networks, the Internet, or any desired network topology. Core network 14 may control the forwarding of data from UE device 10 to other end hosts of the network. Core network 14 may control the operation of base stations 12, may serve wireless data for transmission to UE devices 10, may receive wireless data from UE devices 10 (via base stations 12), etc. Core network 14 may be operated by the network operator or service provider of base stations 12, by a service provider associated with the operating system and/or manufacturer of one or more UE devices 10, or may be any other desired network or sub-network within communications system 20. Core network 14 and base stations 12 may sometimes be referred to collectively herein as network 22.

Base station 12 may include one or more antennas (e.g., antennas arranged in one or more phased antenna arrays for conveying signals at frequencies greater than 10 GHz or other antennas for conveying signals at lower frequencies) that provides wireless coverage for UE devices 10 located within a corresponding geographic area or region, sometimes referred to as a cell. The size of the cell may correspond to the maximum transmit power level of base station 12 and the over-the-air attenuation characteristics for radio-frequency signals conveyed by base station 12, for example. When a UE device 10 is located within the cell, the UE device may connect with base station 12 (sometimes referred to herein as attaching to base station 12) and may then communicate with base station 12 over a wireless link. To support the wireless link, base station 12 may transmit radio-frequency signals in a downlink (DL) direction from base station 12 to the UE device and/or the UE device may transmit radio-frequency signals in an uplink (UL) direction from the UE device to base station 12 (e.g., the wireless links may be bidirectional links).

In the example of FIG. 1, a given UE device 10 may be located in the vicinity of a given base station 12 (e.g., within the cell of base station 12). UE device 10 may therefore communicate with base station 12 over a corresponding wireless link. Radio-frequency signals 16 (e.g., cellular signals) may be conveyed between UE device 10 and base station 12 to support the wireless link. There may also be a set 18 of other UE devices 10 in communications system 20. Set 18 may include UE devices that also communicate with/via network 22 and/or may include UE devices that are in the same geographic area, vicinity, location, city, state, country, or region as UE device 10, for example. The UE devices in set 18 may transmit data to and/or may receive data from UE device 10 (e.g., using radio-frequency signals 16 conveyed with base station(s) 12, via other network nodes in communication system 20 such as a wireless access point, and/or via direct signals transmitted between the UE devices such as sidelink signals, wireless local area network (e.g., Wi-Fi) signals, peer-to-peer (P2P) signals, Bluetooth (BT) signals, device-to-device (D2D) signals, etc.).

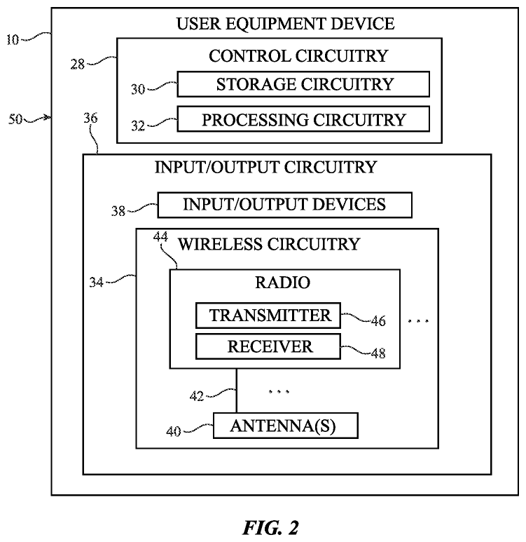

FIG. 2 is a block diagram of an illustrative UE device 10. UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 28 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as one or more software applications (apps). The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications.

To support interactions with external communications equipment, control circuitry 28 may be used in implementing communications protocols. Communications protocols that may be implemented using control circuitry 28 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol. Radio-frequency signals conveyed using a cellular telephone protocol may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 28 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband circuitry (e.g., one or more baseband processors), digital control circuitry, analog control circuitry, and/or other control circuitry that forms part of radio 44. The baseband circuitry may, for example, access a communication protocol stack on control circuitry 28 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34.

Prior to conveying wireless signals via network 22, UE device 10 may first wirelessly connect (attach) to one of the base stations 12 (cells) of network 22. The connection may have an associated connectivity configuration (sometimes referred to herein as a connection configuration or a network connection configuration). The connectivity configuration may specify which base station 12 the UE device is connected to and information about when and how the UE device communicates with that base station 12 (e.g., information identifying the frequencies used for communication, signal beams used for communication, timing or synchronization information, scheduling information, etc.).

Connectivity (attachment) decisions are performed to determine the connectivity configuration for UE device 10 prior to the UE device connecting to the network. Connectivity decisions are also performed to update the connectivity configuration as necessary over time to optimize wireless performance of UE device 10 and/or network 22 (e.g., to hand the UE device over from a first base station to a different base station, from a first signal beam to a second signal beam, from a first frequency to a second frequency, to reschedule wireless data transmission to a later time, etc.).

In cellular telephone networks, connectivity decisions are generally performed by the network and are not performed by the UE device. Such network-based connectivity decisions are based on reactive signaling between the network and the UE device, where the UE device first transmits a request to connect to the network (e.g., a request for the network to generate a connectivity configuration for the UE device). The network and/or UE device then transmit wireless signals, and the network and/or the UE device gather and share measurements of the transmitted wireless signals. The network then generates a connectivity configuration for the UE device based on the measurements and then transmits a response to the UE device to implement the connectivity configuration and to connect (attach) the UE device to the network. Once connected, the UE device and the network convey wireless communications data.

Performing network connectivity decisions at the network/base station (e.g., using reactive signaling) has several drawbacks. For example, the connectivity decisions do not take advantage of contextual information that can be shared to make better-informed decisions and anticipatory actions. For example, some network connectivity decisions may result in better wireless performance at UE device 10 and/or for the network than other network decisions, given the current operating conditions of UE device 10, historical/statistical data associated with the usage of UE device 10, and/or information from other UE devices. As the network generally has no insight into this contextual information, the network is unable to make connectivity decisions that fully takes advantage of the current context of the UE devices, thereby limiting the overall wireless performance of UE device 10 and/or the network.

To mitigate these issues, UE device 10 may autonomously and independently perform network connectivity decisions instead of (or supplemented by) the network. In other words, UE device 10 may generate its own network connectivity configuration and may use that configuration to connect to the network. UE device 10 may make network connectivity decisions based on its own contextual information, based on contextual information from other UE devices such as set 18, and/or based on contextual information from the network. The UE device may receive network context information from network 22 that allows the UE to ensure that its autonomous network connectivity decisions do not excessively deteriorate the overall performance of the network.

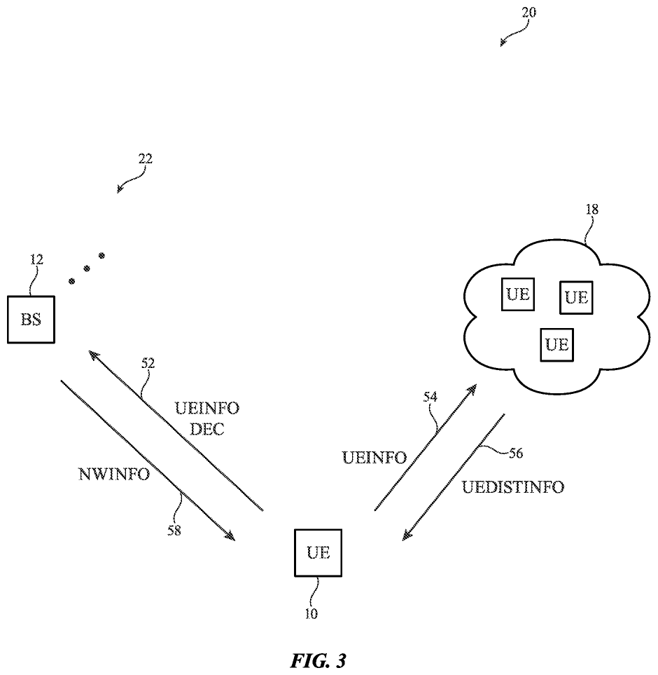

FIG. 3 is a diagram showing how different information may be exchanged within communication system 20 to allow UE device 10 to make network connectivity decisions that optimize wireless performance for UE device 10 and/or network 22. As shown in FIG. 3, UE device 10 may generate its own contextual information UEINFO (sometimes referred to herein as UE device contextual information UEINFO). UE device 10 may transmit UE device contextual information UEINFO to network 22, as shown by arrow 52 (e.g., to one or more base stations 12 using radio-frequency signals 16 of FIG. 1), and/or other UE devices such as the UE devices in set 18, as shown by arrow 54 (e.g., via network 22, direct signaling, one or more wireless access points, the cloud, etc.).

UE device 10 may also receive distributed contextual information UEDISTINFO from other UE devices such as the UE devices in set 18, as shown by arrow 56 (e.g., via network 22, direct signaling, one or more wireless access points, the cloud, etc.). In addition, UE device 10 may receive network contextual information NWINFO from network 22, as shown by arrow 53 (e.g., from one or more base stations 12 using radio-frequency signals 16 of FIG. 1).

Network contextual information NWINFO may include information about the network condition/status of network 22. This may include information about the current, expected, past, and/or future traffic load for the cell in which UE device 10 is located and/or in one or more other cells of network 22 (e.g., cells neighboring or adjacent to the current cell of UE device 10). Additionally or alternatively, network contextual information NWINFO may include status information for one or more base stations 12 such as channel quality information, load balancing information, scheduling information, and/or resource management information for one or more base stations 12. Additionally or alternatively, network contextual information NWINFO may include information about the RAT(s) used by network 22, information identifying or about the current cell in which UE device 10 is located and/or one or more other cells of network 22, frequency band information, bandwidth information, geographic information, etc.

UE device contextual information UEINFO may include information about current, expected, future, and/or past user activity or application activity on UE device 10. This may include, for example, information identifying applications or services running on UE device 10 (e.g., application indicators), information generated by applications or services running on UE device 10, information about battery usage and/or memory resource usage on UE device 10, historical or statistical information identifying past operations, past outputs, past usage, and/or usage history of applications or services running on UE device 10. UE device contextual information UEINFO may also include information identifying the current, past, expected, and/or future position, velocity, and/or motion of UE device 10 (e.g., sensor data generated on UE device 10), information or insights associated with user behavior in interacting with UE device 10 (e.g., information identifying habits of a user in interacting with UE device 10), etc. UE device contextual information UEINFO may include timestamp information corresponding to one or more of these types of information. Distributed contextual information UEDISTINFO may include some or all of UE device contextual information UEINFO generated by other UE devices in set 18 and/or any other desired contextual information.

UE device 10 may generate and update UE device contextual information UEINFO over time. UE device 10 may continuously, periodically, or upon request, receive distributed contextual information UEDISTINFO and/or network contextual information NWINFO. UE device 10 may generate and/or update (e.g., train) one or more machine learning (ML) models (sometimes referred to herein simply as learning models) based on UE device contextual information UEINFO, distributed contextual information UEDISTINFO, and/or network contextual information NWINFO (e.g., models of the statistical/historical/expected behavior of some or all of network 22, UE device 10, and/or other similarly-situated UE devices such as the UE devices set 18). UE device 10 may use the learning model, UE device contextual information UEINFO, distributed contextual information UEDISTINFO, and/or network contextual information NWINFO to make network connectivity decisions (e.g., to generate a network connectivity configuration for UE device 10 independent network 22).

Once UE device 10 has made a network connectivity decision (sometimes referred to herein as performing a network connectivity action or generating a network connectivity configuration), UE device 10 may transmit connectivity decision information DEC to network 22. Connectivity decision information DEC may include information identifying the network connectivity decision, action, and/or configuration generated by UE device 10. Additionally or alternatively, connectivity decision information DEC may include wireless data that UE device 10 is transmitting while operating under its generated connectivity configuration (e.g., connectivity decision information DEC may include data transmitted by UE device 10 while implementing its connectivity decision, action, or configuration).

Transmitting UE device contextual information UEINFO to network 22 may allow network 22 to update its own network connectivity decisions for other UE devices, to assist, supplement, or update a network connectivity decision performed by UE device 10, and/or to track the behavior of UE device 10 for performing any other desired network operations. Transmitting UE device contextual information UEINFO to the UE devices in set 18 may allow the UE devices in set 18 to update their own learning models and to perform their own network connectivity decisions (e.g., while increasing the size of the data set used in the learning models beyond the data produced by a single UE device). Prior to transmission to network 22 or set 18, UE device contextual information UEINFO may be stripped of private information, user data, and personally identifiable information to help preserve the privacy of UE device 10 to the rest of the network.

If desired, the information included in the shared contextual information may be agreed upon in advance between the network and UE device 10. The periodicity with which the contextual information is shared may also be agreed upon in advance between the network and UE device 10. The contextual information may be transmitted via data payloads in wireless packets (e.g., control packets) exchanged between UE device(s) 10 and/or network 22, if desired. Distributing contextual information between the nodes of communication system 20 may allow both the UE device and the network to benefit during subsequent communications.

Consider an example in which UE device 10 receives information about the network condition of network 22, such as neighboring cell traffic loads (e.g., in network contextual information NWINFO), prior to running an application that requires cellular activity (e.g., a data download from network 22). Based on the current network state (e.g., as shared with UE device 10 by network 22 in network contextual information NWINFO) and based on the current internal state of UE device 10 (e.g., as indicated in UE device contextual information UEINFO), UE device 10 may determine whether the application will be able to run with satisfactory levels of performance under the current conditions of network 22 and given the current quality of service (QoS) requirements of the application (e.g., the current application data sensitivity of the application). The UE device may make a connectivity decision based on this information. The connectivity decision may be to either run the application with specific network parameters (e.g., with a particular data rate, at a particular time, with a particular base station, with a particular frequency, using a particular signal beam, with a particular data quality, at a particular location, etc.), to delay or reschedule running of the application and/or download of the data required by the application, or to negotiate a different connectivity configuration with the network, as examples.

Distributing contextual information between the nodes of communication system 20 may also allow UE device 10 and the network to perform machine learning algorithms to generate, based on the contextual information, superior connectivity configurations for different activities, applications, or services that may be required in the future (e.g., to make more informed connectivity decisions in the future, based on the current or past context of the UE device(s) and/or network). If desired, UE device 10 may transmit information or insights from its learning model to network 22 (e.g., within UE device contextual information UEINFO). The network may then use the information or insights from the learning model on UE device 10 to update its own learning model for use in performing future network connectivity decisions (e.g., load balancing, scheduling, resource management, etc.). For example, if the contextual information indicates that, every day, a particular category/type of application is run by many UE devices at a particular location and at a particular time, network connectivity configurations that offload UE devices to a neighboring cell (or using a specific numerology) may help to mitigate high user density, thereby reducing the burden on the network and optimizing wireless communication quality for all of the UE devices communicating with network 22.

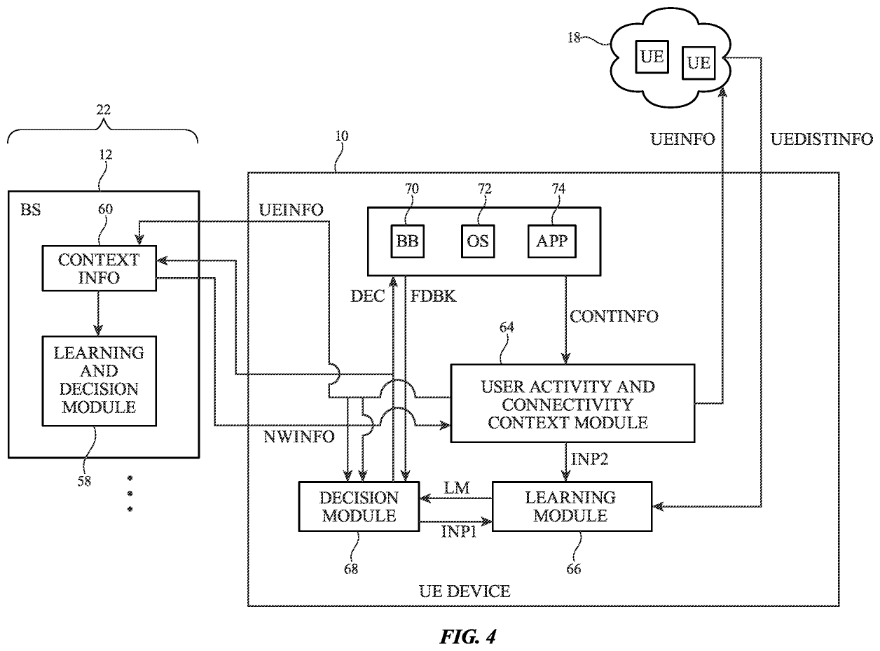

FIG. 4 is a diagram showing how UE device 10 may perform network connectivity (connection) decisions based on contextual information from different nodes in communication system 20. As shown in FIG. 4, UE device 10 may include control elements such as baseband (BB) circuitry 70 (e.g., one or more baseband processors), operating system (OS) 72, and application (APP) 74. BB circuitry 70 may form part of control circuitry 28 of FIG. 2 and OS 72 and application 74 may be stored on storage circuitry 30 and may be executed by processing circuitry 32 of FIG. 2 (e.g., BB circuitry 70, OS 72, and application 74 may form part of control circuitry 28 of FIG. 2). Application 74 may be an application which requires a network connection (e.g., for downloading or uploading wireless application data to the network).

UE device 10 may also include logic such as user activity and connectivity context module 64 (sometimes referred to herein as user activity and connectivity context unit 64), (machine) learning module 66 (sometimes referred to herein as learning unit 64), and decision module 68 (sometimes referred to herein as decision unit 68). Network 22 (e.g., one or more base stations 12) may also store contextual information 60 and may include learning and decision module 58. Modules 58, 68, 66, and 64 may be implemented using hardware (e.g., analog or digital logic gates, registers, memory, one or more processors, storage, etc.) and/or using software (e.g., software stored on storage and executed by one or more processors that, when executed, performs the operations of the modules as described herein).

As shown in FIG. 4, user activity and connectivity context module 64 may receive network contextual information NWINFO from network 22. User activity and connectivity context module 64 may also receive context information CONTINFO from BB circuitry 70, OS 72, and/or application 74. Context information CONTINFO may include information identifying application 74, information required by application 74, information identifying the application data sensitivity (e.g., required QoS) of application 74, information identifying how UE device 10 is being operated, information identifying the current location, position, and/or velocity of UE device 10 (e.g., sensor data), time information, and/or any other desired contextual information associated with the operation of UE device 10.

User activity and connectivity context module 64 may accumulate and generate UE device contextual information UEINFO based on context information CONTINFO and/or network contextual information NWINFO and may transmit UE device contextual information UEINFO to network 22. User activity and connectivity context module 64 may also transmit UE device contextual information UEINFO to other UE devices such as UE devices in set 18. The UE device contextual information UEINFO transmitted to set 18 may be the same as the UE device contextual information UEINFO transmitted to network 22 or may be different from the UE device contextual information UEINFO transmitted to network 22 (e.g., may be a subset of the UE device contextual information UEINFO transmitted to network 22).

User activity and connectivity context module 64 may produce an input INP2 that is received by learning module 66 (e.g., that includes some or all of UE device contextual information UEINFO, network contextual information NWINFO, and/or other information). Learning module 66 may also receive distributed contextual information UEDISTINFO from other UE devices such as the UE devices in set 18 (e.g., UE devices situated in a similar context to UE device 10, such as UE devices that are also communicating with network 22, that are located nearby to or in the same region as UE device 10, etc.).

Learning module 66 may store, maintain, and update (e.g., train or teach) a machine learning model that learns the behavior of UE device 10, other UE devices such as the UE devices in set 18, and/or network 22 based on input INP2, distributed contextual information UEDISTINFO, and/or an additional input INP1 received from decision module 68. Using distributed contextual information UEDISTINFO as an input to learning module 66 may allow UE device 10 to learn the behavior of other UE devices in similar contexts to UE device 10, thereby increasing the size of the data set for the learning model, and allowing the learning model to more accurately reflect expected future behavior for UE device 10 (e.g., for performing better network connectivity decisions than when no learning model is used). Learning module 66 may output learning model information LM to decision module 68. Learning model information LM may include the some or all of the learning model and/or may include an output of the learning model such as, for example, a contextual inference about the current, expected, or future behavior of UE device 10 as learned from distributed contextual information UEDISTINFO, UE device contextual information UEINFO, and/or network contextual information NWINFO. As used herein, the term “behavior” means the behavior of UE device 10 and/or a user of UE device 10, information about activity of UE device 10 and/or the user of UE device 10, behavior and activity patterns (BAP) of or associated with UE device 10 and/or the user of UE device 10, any desired inference about UE behavior/activity, and/or any desired information, inference, and/or prediction about the state of UE device 10 (e.g., device state, connectivity conditions, battery state, processing resources, etc.), etc. The contextual information described herein may include information about or identifying such behavior. Decision module 68 may generate the connectivity decision (e.g., may determine a connectivity action or generate a connectivity configuration) for UE device 10 based on learning model information LM (and thus distributed contextual information UEDISTINFO), network contextual information NWINFO, and/or UE device contextual information UEINFO. Decision module 68 may output connectivity decision information DEC. Decision module 68 may transmit connectivity decision information DEC to network 22 and/or to learning module 66 (e.g., in input INP1) for use in updating the learning model. Decision module 68 may transmit connectivity decision information DEC to BB circuitry 70, OS 72, and/or application 74.

Learning module 66 may provide the necessary contextual information (e.g., historical information, statistical information, behavior predictions, and/or behavior forecasts) to decision module 68 for decision module 68 to perform a network connectivity decision (e.g., for performing a network connectivity action). Learning module 66 may be trained off-line from UE-network contextual data if desired. Decision module 68 may, if desired, include a learning agent that learns from experience using online learning approaches. BB circuitry 70, OS 72, and/or application 74 may generate feedback FDBK from connectivity decision information DEC and may transmit the feedback to decision module 68. This may allow decision module 68 to further refine (learn) its decision-making algorithm over time. Decision module 68 may, if desired, be trained off-line and with multiple users prior to being deployed. For faster model convergence, the training may be tailored towards a specific application category (e.g., application data sensitivity) and/or scenario/use-case. For example, decision module 68 and/or learning module 66 may implement first models for use with streaming applications 74, second models for use with communications applications 74, third models for use with navigation applications 74, etc. The modules may then trigger/use the corresponding models for the type of application 74 currently being run to connect to the network.

Learning module 66 and/or decision module 68 may be trained using synthetic data (e.g., as generated using a UE-network simulator, theoretical models, experimental models, etc.) and/or real-world data (e.g., from UE device 10 itself and/or other UE devices such as the UE devices in set 18). Training the modules and models using real-world data may make the model(s) more realistic than training using only synthetic data. Model testing and validation may be performed in the field (e.g., using real users' feedback and evaluation). The model may also be updated periodically based on observed system changes (e.g., the addition of new RATs to the network). The on-device model may be improved and augmented using federated (distributed) learning across other devices (e.g., set 18) that can share model parameters locally or via the cloud.

Network 22 may store contextual information 60 that includes contextual information about network 22 (e.g., as included in network contextual information NWINFO) and/or contextual information about UE device 10 (e.g., as received in or UE device contextual information UEINFO) and/or other UE devices. Network 22 may update contextual information 60 based on the UE device contextual information UEINFO and/or the connectivity decision information DEC received from UE device 10. Network 22 may maintain its own learning model on learning and decision module 58. Learning and decision module 58 may store, maintain, and update (e.g., train or teach) a learning model that learns the behavior of network 22, UE device 10, and/or other UE devices such as the UE devices in set 18 based on contextual information 60. Network 22 may use the learning model and contextual information 60 to generate or update the network connectivity configuration (e.g., to perform network connectivity decisions or actions) for UE devices in communication system 20 (e.g., UE devices that do not autonomously perform their own network connectivity decisions) and/or to supplement network connectivity decisions performed by UE device 10 (e.g., via transmission of updated and learned network contextual information NWINFO to UE device 10).

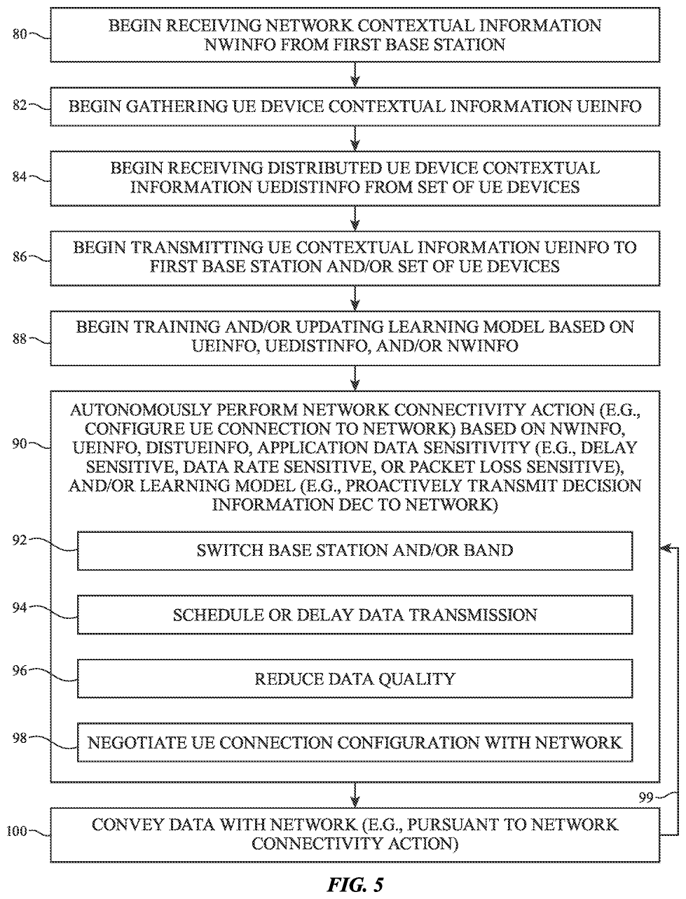

FIG. 5 is a is a flow chart of illustrative operations involved in using UE device 10 to autonomously perform a network connectivity action independent of network 22 (e.g., rather than performing reactive signaling with network 22, allowing network 22 to make the connectivity decision, etc.). The network connectivity action may, for example, involve configuration or reconfiguration of the connection of UE device 10 to the network for conveying wireless data required by application 74.

At operation 80, UE device 10 (e.g., user activity and connectivity context module 64) may begin receiving network contextual information NWINFO from network 22 (e.g., one or more base stations 12). If desired, UE device 10 may receive additional (e.g., updated) network contextual information NWINFO from network 22 at one or more times (e.g., may continue to receive network contextual information NWINFO from network 22) during one or more of the remaining operations of FIG. 5.

At operation 82, UE device 10 may begin gathering UE device contextual information UEINFO (e.g., using BB circuitry 70, OS 72, application 74, and/or user activity and connectivity context module 64). If desired, UE device 10 may continue to gather/update UE device contextual information UEINFO during one or more of the remaining operations of FIG. 5.

At operation 84, UE device 10 (e.g., learning module 66) may begin receiving distributed contextual information UEDISTINFO from the UE devices in set 18. If desired, UE device 10 may receive additional (e.g., updated) distributed contextual information UEDISTINFO from set 18 at one or more times (e.g., may continue to receive network distributed contextual information UEDISTINFO from set 18) during one or more of the remaining operations of FIG. 5.

At operation 86, UE device 10 may begin transmitting UE device contextual information UEINFO to network 22 (e.g., a first base station 12) and/or set 18. If desired, UE device 10 may transmit additional (e.g., updated) UE device contextual information UEINFO to network 22 and/or set 18 at one or more times (e.g., may continue to transmit UE device contextual information UEINFO) during one or more of the remaining operations of FIG. 5.

At operation 88, UE device 10 (e.g., learning module 66) may begin training and/or updating the learning model implemented by learning module 66 based on UE device contextual information UEINFO, network contextual information NWINFO, and/or distributed contextual information UEDISTINFO. If desired, UE device 10 may continue training the learning model during one or more of the remaining operations of FIG. 5. Operations 80, 82, 84, 86, and/or 88 may be performed concurrently.

At operation 90, UE device 10 (e.g., decision module 68) may autonomously (independently) perform a network connectivity action (e.g., may make a network connectivity decision to generate, select, update and/or implement a network connectivity configuration for UE device 10, etc.) based on UE device contextual information UEINFO, network contextual information NWINFO, distributed contextual information UEDISTINFO, an output from the learning model (e.g., learning model information LM), and/or application data sensitivity information. Put differently, UE device 10 may configure the connection for UE device 10 to network 22 based on UE device contextual information UEINFO, network contextual information NWINFO, distributed contextual information UEDISTINFO, an output from the learning model, and/or the application data sensitivity. UE device 10 may transmit corresponding connectivity decision information DEC to network 22 (e.g., the first base station). Operation 90 may, for example, be performed without performing reactive signaling with the network and without the network making network connectivity decisions for UE device 10.

The network connectivity action (e.g., the implemented network connectivity configuration) may depend on the objective optimization and user priority. For example, if the primary goal is to save battery, the network connectivity actions may be tailored towards reducing battery consumption. If desired, decision module 68 may include different sub-modules that are used depending on the target action set. The network connectivity action may be performed at different levels of the device stack (e.g., at the application level, such as to lower the codec, at the baseband level, such as to select a different frequency band, etc.). In general, the application processor on UE device 10 or the user may decide how to perform the recommended action.

The network connectivity action may include, as one example, switching from the first base station 12 to a second base station 12 (e.g., from a neighboring cell) and/or from a first frequency band to a second frequency band for conveying wireless data for application 74 (e.g., at operation 92). In this situation, connectivity decision information DEC may include wireless data proactively transmitted to the second base station and/or in the updated frequency band, may include information indicating that UE device 10 is about to or has switched to communicating with the second base station and/or in the updated frequency band, and/or may include a request, negotiation, or instruction to the network to hand UE device 10 over to the second base station and/or updated frequency band.

As another example, the network connectivity action may include scheduling or delaying wireless data transmission (operation 94). In this situation, UE device 10 may transmit wireless data for application 74 to network 22 (e.g., as connectivity decision information DEC) immediately or after a delay, or may begin receiving wireless data for application 74 from network 22 immediately or after a delay (e.g., connectivity decision information DEC may include a request for download of the wireless data immediately or at a later time). The scheduling/delay may be on the scale of milliseconds, seconds, minutes, or hours, for example. Connectivity decision information DEC may, if desired, include information identifying the schedule for the conveyance of wireless data between the network and UE device 10 and/or information identifying a later time at which the wireless data is to be conveyed. If desired, UE device 10 may delay transmission of connectivity decision information DEC (e.g., the wireless data or information associated with the schedule or timing for the wireless data to be conveyed for application 74).

As another example, the network connectivity action may include the adjustment (e.g., increase or decrease) in the data quality for application 74 (operation 96). In this situation, connectivity decision information DEC may include wireless data identifying that network 22 should transmit (downlink) wireless data to UE device 10 at a different (e.g., reduced) data quality and/or may include wireless data that is itself transmitted at a different (e.g., reduced) data quality.

Operations 92-96 may be performed proactively and autonomously independent of the network. If desired, at operation 98, the network connectivity action may include the negotiation of the selected network connectivity configuration for UE device 10 with network 22. In this situation, connectivity decision information DEC may include information identifying the network connectivity configuration and/or a request for to the network for UE device 10 to implement the selected network connectivity configuration. Network 22 may immediately begin to implement the requested configuration, may transmit a signal to UE device 10 instructing the UE device that the requested configuration has been accepted, and/or may transmit a signal to UE device 10 proposing a different configuration that is selected based on the requested configuration.

In general, applications such as application 74 may have a corresponding application data sensitivity. Application 74 may, for example, be delay sensitive, data rate sensitive, or packet loss sensitive. The network connectivity action performed at operation 90 may be performed based at least in part on the application data sensitivity of application 74 (e.g., based on whether application 74 is delay sensitive, data rate sensitive, or packet loss sensitive).

Delay sensitive applications require real-time processing and as fast a reaction time as possible. One example of a delay sensitive application is a driving assistance or automated driving application (e.g., an application in which a fast response is required to ensure safe conditions). Data rate sensitive applications are applications that require large quantities of data. One example of a data rate sensitive application is a media playback application that supports streaming of high resolution or 4K videos. Packet loss sensitive applications are applications that require as low a packet loss as possible. Examples of packet loss sensitive applications include voice call (e.g., voice-over-IP) applications and video call applications. If desired, learning module 66 may include and train a first learning model for delay sensitive applications, a second learning model for data rate sensitive applications, and a third learning model for packet loss sensitive applications (e.g., for use in performing network connectivity actions depending on the type of application 74 requesting wireless data transfer).

Consider a few potential use cases for how UE device 10 may autonomously perform a network connectivity action based on the contextual information (e.g., while processing operation 90). In a first potential use case (e.g., a deferred data transfer scenario, which may be associated with operation 94), UE device 10 may wish to begin data transfer for application 74 as soon as possible. UE device 10 may first identify the traffic load on the first base station 12 and/or other base stations in network 22 based on the received network contextual information NWINFO. If the network has indicated that the traffic load is excessive, UE device 10 (e.g., decision module 68) may then identify the application data sensitivity. If the application data sensitivity is delay sensitive (e.g., when application 74 requests to perform a voice call), the network connectivity action may be to run the application and to begin the voice call (e.g., to convey the corresponding wireless data and/or control signaling to network 22 to begin/initiate the voice call).

On the other hand, if the application is not delay sensitive (e.g., application 74 requests to send an email), the network connectivity action may be to delay running the application and/or to delay transmission of the corresponding wireless data (e.g., the email) to network 22. UE device 10 may then use UE device contextual information UEINFO, network contextual information NWINFO, and/or distributed contextual information UEDISTINFO to schedule (delay) the application until a later time (e.g., when the network traffic load is, based on the network contextual information, expected or forecast to be lower than the current traffic load). The decision to begin or delay/schedule conveying the wireless data for application 74 is performed by UE device 10 independent of network 22 (rather than by network 22), allowing the network connectivity decision to be based on application data sensitivity and contextual information available at UE device 10 but not necessarily network 22.

In a second potential use case (e.g., an anticipated data transfer scenario, which may be associated with operation 94), application 74 may involve regular (e.g., periodic) transfer of wireless data to UE device 10, such as when application 74 is a streaming application and the user of UE device 10 is watching a series on the application. In this example, the UE device contextual information UEINFO may indicate that the user usually or often uses the application to download/stream clusters of wireless data (e.g., videos from the series) at particular times on particular days.

In this situation, the network connectivity action may involve the proactive download of additional wireless data (e.g., one or more subsequent videos from the series) to UE device 10 at times when the network contextual information NWINFO indicates that traffic load (e.g., at or around the expected location of UE device 10 as indicated by UE device contextual information UEINFO) will be relatively low and/or at times when the UE device contextual information UEINFO indicates that the UE device will have a well-charged battery. Once the wireless data has been downloaded, the application may then process the downloaded wireless data (e.g., play back downloaded videos) on demand at a later time, without adding any additional traffic to the network. In this way, the traffic load at the network may be reduced during times and at locations where the network contextual information NWINFO indicates that traffic load is typically or likely to be high.

In a third potential use case (e.g., a user profiling scenario), in a given geographical area, at a particular time of day, distributed contextual information UEDISTINFO and/or network contextual information NWINFO may indicate that some UE devices in set 18 often use first application 74 or first type of application 74 to that require a first type of wireless data (e.g., to stream 4K videos), whereas other UE devices in set 18 often use a second application 74 or second type of application 74 (e.g., a website browser or social media application) that require a second type of wireless data, and other UE devices 10 in set 18 often use a third application 74 or third type of application 74 (e.g., virtual reality games) that require a third type of wireless data. In this situation, UE device 10 may learn, from distributed contextual information UEDISTINFO and/or network contextual information NWINFO, what is the typical usage of the network for its current or expected context (e.g., time and/or place). The network connectivity action may then include the optimization and/or generation of a network connectivity configuration based on the typical behavior of UE devices with a similar context to UE device 10, which may reduce load on the network as well as potential signaling overhead.

In a fourth potential use case (e.g., a proactive mobility scenario), distributed contextual information UEDISTINFO and/or network contextual information NWINFO may indicate that at a particular location, UE devices often have a connection failure or excessive beam-switching overhead (e.g., at a location on a road right before a tunnel). UE device 10 may learn from user patterns (e.g., at learning module 66 and based on distributed contextual information UEDISTINFO) that it should proactively switch to a lower frequency band that is less likely to produce a connection failure when the UE device is at or approaching that location (e.g., when the UE device is using a similar type of application at that or approaching the location). In other words, the network connectivity action may be the switching to a lower frequency band that is less likely to drop a connection at or near the corresponding location (e.g., at operation 92).

In a fifth potential use case (e.g., another proactive mobility scenario), UE device contextual information UEINFO may indicate that UE device 10 typically performs a daily commute while using a calling application 74 to perform a phone call. UE device 10 may learn, from the cellular connectivity history of UE device 10 when using that calling application 74, to identify failure locations (e.g., previous locations where the call was dropped). The UE device may then proactively take network connectivity actions to prevent the call from being dropped when the UE device again approaches the failure locations (e.g., by switching frequency band and/or base station at operation 92 and/or by reducing data quality at operation 96). If desired, the UE device may share this contextual information with other UE devices in set 18 so those UE devices may also take proactive connectivity actions to avoid dropping calls at those locations when using the same or similar applications 74. These examples are illustrative and non-limiting.

At operation 100, UE device 10 may begin or continue to convey wireless data with network 22 pursuant to the network connectivity action performed at operation 90. Processing may loop back to operation 90 via path 99 and UE device 10 may continue to update the network connectivity configuration as needed.

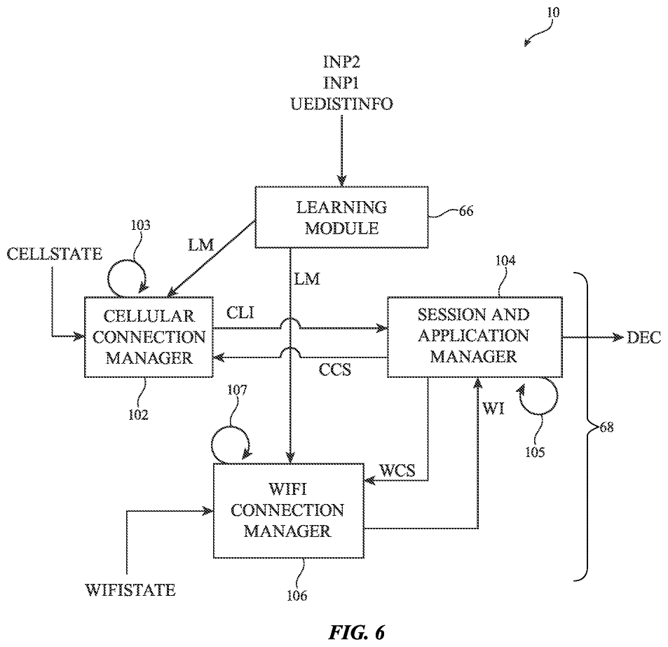

If desired, this UE device-driven network connectivity framework may be extended beyond a single RAT (e.g., beyond cellular connectivity). FIG. 6 is a diagram showing how UE device 10 may make network connectivity decisions (e.g., may perform network connectivity actions) across multiple radio access technologies (RATs) such as cellular and Wi-Fi.

As shown in FIG. 6, decision module 68 on UE device 10 may include a first sub-module that operates on a first RAT such as cellular connection manager 102, may include a second sub-module that operates on a second RAT such as Wi-Fi connection manager 106, and may include a session and application manager 104. Learning module 66 may generate learning model information LM based on one or more inputs (e.g., UEDISTINFO, INP2, and INP1). Learning module 66 may pass learning model information LM to cellular connection manager 102 and Wi-Fi connection manager 106.

Cellular connection manager 102 may receive information CELLSTATE about the current cellular radio state of network 22 (e.g., in network contextual information NWINFO). Cellular connection manager 102 may make cellular network connectivity decisions (e.g., 5G and/or 6G configuration decisions) over time based on information CELLSTATE and learning model information LM, as shown by arrow 103. Cellular connection manager 102 may output corresponding cellular decision information CLI (e.g., identifying the cellular network connectivity decisions) to session and application manager 104.

Wi-Fi connection manager 106 may receive information WIFISTATE about the Wi-Fi radio state of network 22 (e.g., in network contextual information NWINFO). Wi-Fi connection manager 106 may make Wi-Fi network connectivity decisions (e.g., link, motion, and/or disconnection decisions) over time based on information WIFISTATE and learning model information LM, as shown by arrow 107. Wi-Fi connection manager 106 may output corresponding Wi-Fi decision information WI (e.g., identifying the Wi-Fi network connectivity decisions) to session and application manager 104.

Session and application manager 104 may make session management, RAT selection, and/or other co-ordination decisions (e.g., inter-RAT coordination decisions) over time based on Wi-Fi decision information WI, cellular decision information CLI, and/or information associated with an application 74 that requires wireless data transfer, as shown by arrow 105. Session and application manager 104 may output corresponding connectivity decision information DEC (e.g., that includes, identifies, or implements the session management, RAT selection, and/or other co-ordination decisions). If desired, session and application manager 104 may generate a cellular configuration suggestion CCS based on the decision and may transmit cellular configuration suggestion CCS to cellular connection manager 102. If desired, session and application manager 104 may generate a Wi-Fi configuration suggestion WCS based on the decision and may transmit Wi-Fi configuration suggestion WCS to Wi-Fi connection manager 106. The example of FIG. 6 is illustrative and non-limiting. Managers 102 and 106 may operate on any desired RATs. Decision module 68 may include more than two managers for operating on more than two RATs if desired.

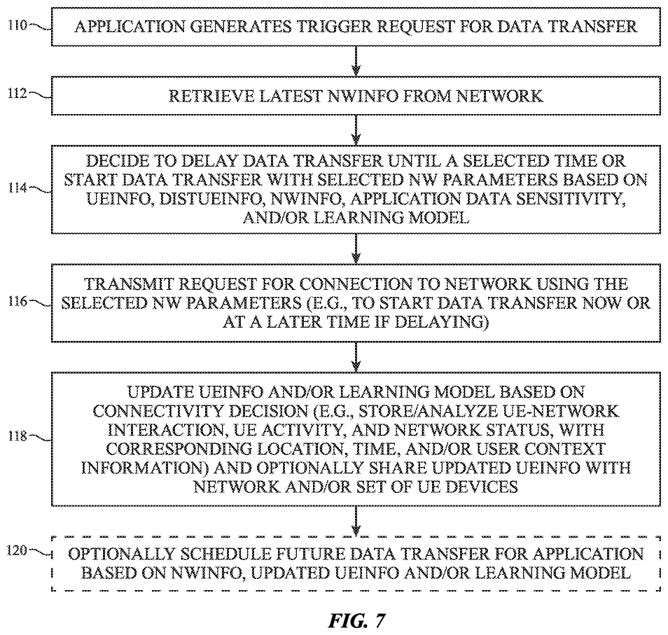

FIG. 7 is a flow chart of operations that may be performed by UE device 10 to make a network connectivity decision to start or delay data transfer (e.g., for performing a network connectivity action to either start or delay data transmission while processing operation 94 of FIG. 5). The operations of FIG. 7 may be performed while processing at least operation 90 of FIG. 5.

At operation 110, an application 74 may generate a trigger request for wireless data transfer with network 22 (e.g., prior to operation 90 of FIG. 5). The request may be triggered by a user input (e.g., a user input to open or run the application, a user input to download a file within the application, etc.) and/or autonomously by application 74, BB circuitry 70, and/or OS 72 (FIG. 4).

At operation 112, UE device 10 may retrieve the latest network contextual information NWINFO from network 22 (e.g., at operation 80 or at any point prior to operation 90 of FIG. 5). For example, UE device 10 may periodically receive network contextual information NWINFO and may identify the latest-received network contextual information NWINFO stored on UE device 10. As another example, UE device 10 may transmit a control signal to network 22 to request the latest network contextual information NWINFO, network 22 may transmit the latest network contextual information NWINFO in response to the request, and UE device 10 may receive the latest network contextual information NWINFO. If desired, UE device 10 may choose when to request the latest network contextual information NWINFO based on the network traffic conditions, history, and/or context, and/or based on the battery level of UE device 10 (e.g., to transmit the request when traffic load is low, battery level is high, etc.).

At operation 114, UE device 10 may decide whether to delay the wireless data transfer requested by application 74 until a later time or to immediately start the wireless data transfer requested by application 74 (e.g., with UE-selected network parameters). UE device 10 may perform this decision based on the latest network contextual information NWINFO (e.g., traffic load, cell status, etc.), the current UE device contextual information UEINFO (e.g., statistical or historical information about UE device 10 operating under a similar time, location, and/or application context), the latest received distributed contextual information UEDISTINFO (e.g., statistical or historical information about the UE devices in set 18 operating under a similar time, location, and/or application context), the application data sensitivity of application 74, and/or the learning model information LM produced by learning module 66 (e.g., for the current time, location, and/or application context of UE device 10). In some implementations, the wireless data transfer may involve starting a proactive download of wireless data (e.g., a video or episode of a series) at a time when the contextual information indicates that the network traffic load will be low and the device will have sufficient battery to perform the download.

At operation 116, UE device 10 may transmit a request for connection to network 22 using the selected network parameters (network connectivity configuration) and/or may proactively begin communication with network 22 according to the selected network parameters. For example, if UE device 10 decided at operation 114 to immediately start data transfer (e.g., because the traffic load for the network is or is expected to be low, because application 74 is delay sensitive, etc.), UE device 10 may immediately begin transmitting the wireless data requested by application 74, transmitting a request for transmission of the requested wireless data to network 22, and/or transmitting a request that the network negotiate with the UE device to implement as close to the selected network parameters as possible. If UE device 10 decided to delay data transfer, UE device 10 may wait until a later time to begin transmitting the wireless data requested by application 74, transmitting a request for transmission of the requested wireless data to network 22, and/or transmitting a request that the network negotiate with the UE device to implement as close to the selected network parameters as possible, and/or may transmit a signal to the network identifying a later time at which the UE device will perform such transmissions.

At operation 118, UE device 10 may update its UE device contextual information UEINFO and/or the corresponding learning model on learning module 66 based on the connectivity decision at operation 114. For example, the UE device may store and/or analyze its UE-network interaction, UE activity, and/or network status with its location, time, and/or other information associated with the context of UE device 10. If desired, UE device 10 may share the updated UE device contextual information UEINFO with network 22 (e.g., for updating the learning model maintained by the network) and/or the UE devices in set 18 (e.g., to update the learning models maintained by the UE devices in set 18).

At optional operation 120, UE device 10 may schedule future data transfer for application 74 based on network contextual information NWINFO, the updated UE device contextual information UEINFO, and/or the updated learning model. For example, UE device 10 may identify a pattern of user behavior, such as the user downloading an episode of a video series daily at night while at home. If traffic conditions are typically poor in the user's home at night, UE device 10 may schedule future downloads of episodes of the video series (e.g., may proactively download the next episode in the video series sometime during the day when the traffic load is low and the device is likely to have high battery level).

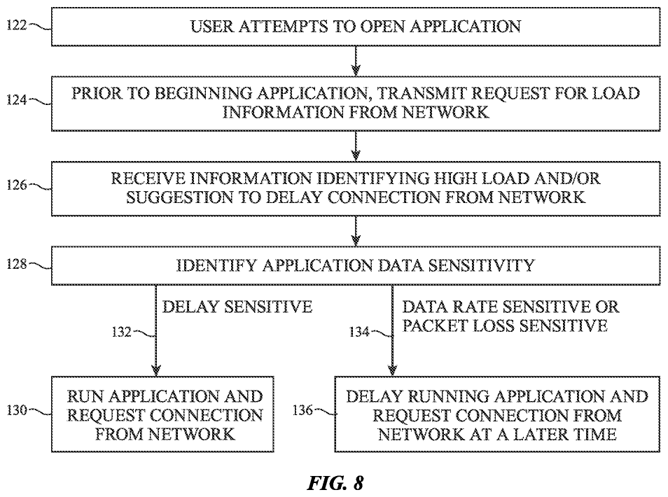

FIG. 8 is a flow chart of operations that may be performed by UE device 10 to make a network connectivity decision based on a connectivity suggestion from network 22 and based on the application data sensitivity of application 74. FIG. 8 may, for example, represent one exemplary use case of the operations of FIG. 7. The operations of FIG. 8 may be performed while processing at least operation 90 of FIG. 5.

At operation 122, a user may attempt to open (e.g., via a user input provided to UE device 10) an application 74 that requires wireless data transfer (e.g., while processing operation 110 of FIG. 7).

At operation 124, prior to beginning the application, UE device 10 may transmit a request for the latest traffic load information to network 22 (e.g., while processing operation 112 of FIG. 7).

At operation 126, UE device 10 may receive, from network 22, information identifying that the traffic load is high and/or a suggestion from the network to delay connection to the network (e.g., within the received network contextual information NWINFO).

At operation 128, UE device 10 may identify the application data sensitivity of application 74. If the application is delay sensitive (e.g., if the application is a voice calling application that requires a voice call to begin as soon as possible), processing may proceed to operation 130 via path 132. At operation 130, UE device 10 may immediately run application 74 and may transmit a request to establish the required connection to network 22 (e.g., while processing operation 116 of FIG. 7).

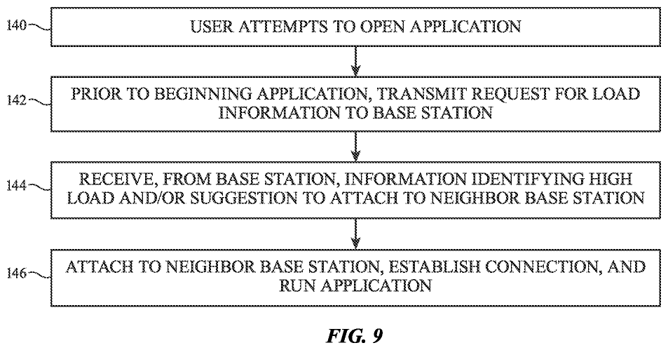

If the application is not delay sensitive (e.g., if the application is data rate sensitive or packet loss sensitive), processing may proceed from operation 128 to operation 136 via path 134. At operation 136, UE device 10 may delay running application 74 until a later time (e.g., when traffic load is expected, based on the network contextual information, to be lower). UE device 10 may then run application 74 at the later time and may transmit the request to establish the required connection to network 22 at that time (e.g., while processing operation 116 of FIG. 7). Processing may proceed from operations 130 and 136 to operation 118 of FIG. 7 if desired. FIG. 9 is a flow chart of operations that may be performed by UE device 10 to make a network connectivity decision to switch between base stations 12. FIG. 8 may, for example, represent one exemplary use case of the operations of FIG. 7. The operations of FIG. 8 may be performed while processing at least operation 90 of FIG. 5 (e.g., operation 92).

At operation 140, a user may attempt to open (e.g., via a user input provided to UE device 10) an application 74 that requires wireless data transfer (e.g., while processing operation 110 of FIG. 7).

At operation 142, prior to beginning the application, UE device 10 may transmit a request for the latest traffic load information to a first base station 12 of network 22 (e.g., while processing operation 112 of FIG. 7).

At operation 144, UE device 10 may receive, from the first base station 12, information (e.g., within the received network contextual information NWINFO) identifying that the traffic load at the first base station is high (or is expected to be high given the current context) and/or a suggestion from the network that the UE device attach/connect to a second base station such as from a cell neighboring the first base station.

At operation 146, UE device 10 may proactively attach (connect) to the second base station, may establish a connection with the second base station, may run application 74 (e.g., immediately or at a delayed time), and may convey the wireless data required by application 74 with the second base station. In this way, wireless performance of UE device 10 and the network itself may be optimized, by moving UE device 10 to the second base station when the traffic load at the first base station is too high. Processing may proceed from operations 130 and 136 to operation 118 of FIG. 7 if desired.

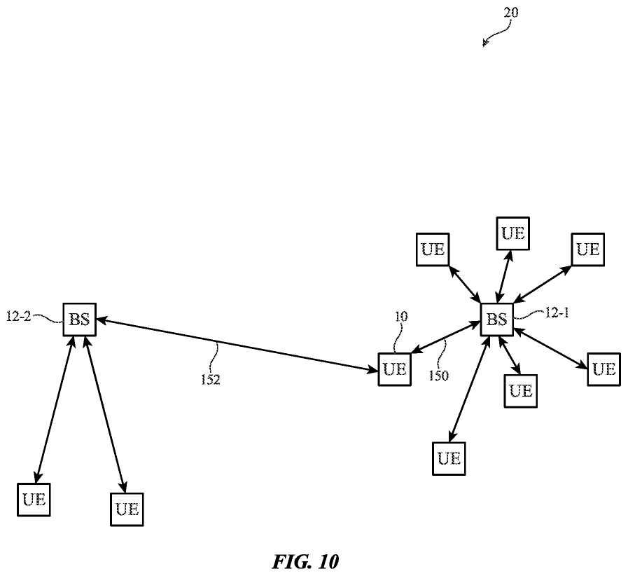

FIG. 10 is a diagram showing how UE device 10 may switch between wireless base stations while processing the operations of FIG. 9. As shown in FIG. 10, UE device 10 may initially request network contextual information NWINFO from a first base station 12-1 using wireless signals 150 (e.g., while processing operation 142 of FIG. 9). First base station 12-1 may be, for example, the base station 12 in network 22 that is located closest to UE device 10 and thus most likely (in the absence of other UE devices) to offer UE device 10 with optimal wireless performance.

As shown in the example of FIG. 10, first base station 12-1 may typically be connected to a large number of other UE devices at a given time of day (e.g., as identified by network contextual information NWINFO), whereas other base stations such as a second base station 12-2 may be connected to a small number of other UE devices at that time. As such, the traffic load at first base station 12-1 is expected to be higher than the traffic load at second base station 12-2. Base station 12-1 may transmit network contextual information NWINFO to UE device 10 (using wireless signals 150) that identifies that the traffic load at first base station 12-1 is relatively high and/or identifying another base station having a lower traffic load such as second base station 12-2 (e.g., while processing operation 144 of FIG. 9).

UE device 10 may then proactively attach to second base station 12-2 without any further signaling with network 22 or first base station 12-1, as shown by signals 152 (e.g., while processing operation 146 of FIG. 9). Even though second base station 12-2 is farther away from first base station 12-1, second base station 12-2 may be statistically more likely to offer UE better wireless performance for UE device 10 at the given time of day than first base station 12-1, due to its historically/expected lower traffic load. Further, re-distributing UE device 10 from first base station 12-1 to second base station 12-2 may reduce the potential traffic load of base station 12-1, thereby improving wireless communications for the other UE devices expected to be connected to base station 12-1 at the given time, and thus the performance of the overall network 22.

UE device 10 and/or network 22 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed by the components of UE device 10, base station(s) 12, and/or network 22 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 30 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 32 of FIG. 2, etc.). The processing circuitry may include microprocessors, central processing units (CPUs), application-specific integrated circuits with processing circuitry, or other processing circuitry.

If desired, an apparatus may be provided that includes means to perform one or more elements or any combination of elements of one or more methods or processes described herein.

If desired, one or more non-transitory computer-readable media may be provided that include instructions to cause an electronic device, upon execution of the instructions by one or more processors of the electronic device, to perform one or more elements or any combination of elements of one or more methods or processes described herein.

If desired, an apparatus may be provided that includes logic, modules, or circuitry to perform one or more elements or any combination of elements of one or more methods or processes described herein.

If desired, an apparatus may be provided that includes one or more processors and one or more non-transitory computer-readable storage media comprising instructions that, when executed by the one or more processors, cause the one or more processors to perform one or more elements or any combination of elements of one or more methods or processes described herein.

If desired, a signal (e.g., a signal encoded with data), datagram, information element (IE), packet, frame, segment, PDU, or message may be provided that includes or performs one or more elements or any combination of elements of one or more methods or processes described herein.

If desired, an electromagnetic signal may be provided that carries computer-readable instructions, where execution of the computer-readable instructions by one or more processors causes the one or more processors to perform one or more elements or any combination of elements of one or more methods or processes described herein.

If desired, a computer program may be provided that includes instructions, where execution of the program by a processing element causes the processing element to carry out one or more elements or any combination of elements of one or more methods or processes described herein.

The foregoing is merely illustrative and various modifications can be made to the described embodiments. The foregoing embodiments may be implemented individually or in any combination.

What is claimed is:

1. A method of operating a user equipment (UE) device, the method comprising:
with one or more antennas, receiving a first signal from a first wireless base station of a cellular network, the first signal including first contextual information about the cellular network;
with one or more processors, wirelessly connecting the UE device to the cellular network based on the first contextual information; and
with the one or more antennas, once the UE device has wirelessly connected to the cellular network, communicating wireless data with the cellular network.

2. The method of claim 1, wherein the first contextual information includes traffic load information associated with the cellular network.

3. The method of claim 2, wherein wirelessly connecting the UE device to the cellular network comprises:
starting or delaying transfer of the wireless data based on the traffic load information, the wireless data being associated with an application running on the UE device.

4. The method of claim 3, wherein wirelessly connecting the UE device to the cellular network further comprises:
starting or delaying transfer of the wireless data based on a data sensitivity of the application.

5. The method of claim 4, wherein wirelessly connecting the UE device to the cellular network further comprises:
starting transfer of the wireless data when the application has a delay sensitive data sensitivity; and
delaying transfer of the wireless data when the application has a data rate sensitive or packet loss sensitive data sensitivity.

6. The method of claim 2, wherein wirelessly connecting the UE device to the cellular network comprises:
switching the UE device, based on the traffic load information, from the first wireless base station to a second wireless base station of the cellular network.

7. The method of claim 1, wherein wirelessly connecting the UE device to the cellular network comprises:
generating a network connectivity configuration for the UE device; and
transmitting, using the one or more antennas, a second signal to the cellular network pursuant to the network connectivity configuration.

8. The method of claim 7, wherein wirelessly connecting the UE device to the cellular network further comprises:
using the second signal to negotiate the network connectivity configuration with the cellular network.

9. The method of claim 1, further comprising:
with the one or more processors, generating second contextual information about the UE device, wherein wirelessly connecting the UE device to the cellular network comprises wirelessly connecting the UE device to the cellular network based on the second contextual information; and
with the one or more antennas, transmitting a second signal to the cellular network that includes the second contextual information.

10. The method of claim 7, further comprising:
with the one or more antennas, receiving a third signal that includes third contextual information about a set of additional UE devices, wherein wirelessly connecting the UE device to the cellular network comprises wirelessly connecting the UE device to the cellular network based on the third contextual information; and
with the one or more antennas, transmitting the second contextual information to the set of additional UE devices.

11. The method of claim 9, wherein the second contextual information comprises: a cellular connectivity history of the UE device, information about usage of an application on the UE device that requests transfer of the wireless data, a location of the UE device, a motion of the UE device, or information about a battery level of the UE device.

12. A method of operating a user equipment (UE) device to communicate with a cellular network, the method comprising:
with one or more processors, generating first contextual information about usage of the UE device; and
with one or more antennas, transmitting a signal to the cellular network that implements, for the UE device and the cellular network, a network connectivity decision that is based on the first contextual information.

13. The method of claim 12, further comprising:
with the one or more antennas, receiving second contextual information about usage of a set of additional UE devices, wherein making the network connectivity decision comprises making the network connectivity decision based on the second contextual information.

14. The method of claim 13, wherein making the network connectivity decision comprises:
selecting an updated frequency band for transmission of the signal based on the first contextual information and the second contextual information.

15. The method of claim 14, wherein the first contextual information includes location information about the UE device, the second contextual information includes information about the set of additional UE devices dropping a connection to the cellular network at a particular location, and selecting the updated frequency band comprises selecting the updated frequency band when the UE device is at or approaching the particular location, and wherein the first contextual information comprises: cellular connectivity history of the UE device, information about usage of an application on the UE device that requests transfer of wireless data with the cellular network, a location of the UE device, a motion of the UE device, or information about a battery level of the UE device.

16. The method of claim 12, further comprising:
with the one or more antennas, transmitting an additional signal to the cellular network that includes the first contextual information.

17. The method of claim 12, wherein the network connectivity decision comprises: a decision to immediately transmit or to delay wireless data transfer with the cellular network, selection of a wireless base station of the cellular network for reception of the signal, selection of a frequency to use for transmission of the signal, or a reduction in data quality of the signal.

18. The method of claim 12, further comprising:
with the one or more processors, training a learning model based on the first contextual information and the second contextual information, wherein making the network connectivity decision comprises making the network connectivity decision based on an output of the learning model.

19. A method of operating a user equipment (UE) device to communicate with a cellular network, the method comprising:
with one or more antennas, receiving a first signal that includes first contextual information about usage of a set of additional UE devices that communicate with the cellular network;
with one or more processors, performing a wireless connectivity action with the cellular network based on the first contextual information; and
with the one or more antennas, transmitting a second signal to the cellular network that implements the wireless connectivity action.

20. The method of claim 19, further comprising:
with the one or more antennas, receiving a third signal from the cellular network that includes second contextual information about usage of the cellular network, performing the wireless connectivity action comprises performing the wireless connectivity action based on the first contextual information, and the wireless connectivity action comprises: immediate transmission of the second signal, delayed transmission of the second signal, selection of a wireless base station of the cellular network for reception of the second signal, selection of a frequency to use for transmission of the second signal, or a reduction in data quality of the second signal.
